(19) United States
(12) Patent Application Publication
(10) Pub. No.: US 2013/0193110 A1
(43) Pub. Date: Aug. 1, 2013

(54) CONTACT ARRANGEMENT FOR HIGH-POWER ELECTRICAL SWITCHING

(71) Applicant: Johnson Electric S.A., Murten (CH)

(72) Inventors: Volkmar HOEHNE, Shatin (HK); Joerg GASSMANN, Shatin (HK); Soeren HEINRICH, Shatin (HK)

(73) Assignee: JOHNSON ELECTRIC S.A., Murten (CH)

(21) Appl. No.: 13/750,216

(22) Filed: Jan. 25, 2013

(30) Foreign Application Priority Data
Jan. 27, 2012 (DE) 10 2012 001 762.6

(51) Int. Cl. H01H 33/02

(52) U.S. Cl. CPC H01H 33/025
USPC 218/146

(57) ABSTRACT

In a contact arrangement for high-power electrical switching devices having at least two circular contact piece pairs in a convex/flat or convex/convex contact piece pair of contact pieces directly connected in parallel, mechanically and electrically in a circuit. A central recess, the largest diameter of which is approximately ⅕ of the contact diameter of a contact piece, is provided in the contact surface of at least one contact piece partner of a contact piece pair. In a convex/concave or flat/concave contact piece pair of contact pieces, however, a positive projection is arranged within the centre of the concave contact surface of a contact piece partner, the largest diameter of which is approximately ⅕ of the contact diameter of the contact piece.

### CROSS REFERENCE TO RELATED APPLICATIONS

This non-provisional patent application claims priority under 35 U.S.C. §119(a) from Patent Application No. 10 2012 001 762.6 filed in Germany on Jan. 27, 2012.

### FIELD OF THE INVENTION

This invention relates to a contact arrangement for high-power electrical switching devices having at least two parallel contact piece pairs.

### BACKGROUND OF THE INVENTION

1. Technical Field

In order to improve the contact properties and durability with regard to burn-off, the currents of a current path are often divided into two or more parallel contact points in electrical switching devices of greater switching capability. For this, depending on their design, the movable contact piece carriers support at one end or at both ends two or even more mostly circular contact pieces side by side, which work together with their assigned mostly circular counter contact points. Accordingly, the movable contact piece carriers are swivelled on the side of the current outlet, clamped firmly with automatic spring action, or they are designed as bridge contact piece carriers, on the ends of which on both sides are parallel contact pieces which correspond with appropriate counter contact pieces in pairs. The movable contact piece carriers may also be longitudinally slotted or mechanically but not electrically separated, wherein each part of the contact piece carrier carries at least one contact piece. The corresponding counter contact pieces for the contact piece pairs are usually arranged on fixed contact piece carriers. The adjacent contact surfaces of the contact pieces of a contact piece pair for switching devices of greater performance are preferably to be found in a flat/convex, convex/convex and more rarely a convex/concave combination. The contact pieces may generally be made from a high grade contact material or be made from a less high grade supporting material and a plated high grade contact material. They are riveted or soldered to the contact piece carriers. All of them, except for the last-mentioned configurations, are realised by the invention.

2. Prior Art

EP 1 575 075 A2 discloses a known contact arrangement having two parallel contact piece pairs, which in order to increase the reliability of the contact of electromagnetic relays, comprises a one-piece, one-sided clamped contact spring which carries two parallel contact pieces on the flexible exposed end, wherein in an alternative arrangement two corresponding counter contact pieces are arranged on a fixed contact piece carrier. A closing with reduced bouncing and a mode of operation having pre- and main contact is achieved by inclinations of the contact spring or the fixed contact carrier. Since the first closing and last opening pre-contact comprises a load contact and wears out more quickly, it has larger dimensions than the other one and yet is made from a less high grade contact material.

Based on the realisation that in a twin contact a contact pair always remains intact, even if the other contact pair in the course of time is affected by switching under full load, an electrical twin contact arrangement made of dissimilar materials having moving contact pieces also switching consecutively is known from DE 1 175 807 B. The two crowned contact pieces are arranged on each limb of the forked slotted tongue on the flexible ends, while the flat fixed contact pieces of unequal height are attached to a common fixed contact piece carrier.

According to DE 199 39 966 C1 a height misalignment of the contact piece parts of a contact spring for electrical rocker switches caused by production should be compensated for by means of a large defined torsion movement around the longitudinal axis of the contact spring.

A contact arrangement for high voltage relays having two mechanically and electrically parallel contact springs clamped on one side, which each carry on one side a contact piece and work on two likewise mechanically and electrically connected parallel fixed contact pieces, is, for example, evident from DE 102 49 697 B3. A switching mechanism engages, with the aim of activating the contact springs, with the ends of the contact springs extending beyond the contact pieces. When contacts do not close at the same time, the laminated armature spring swivels as soon as the leading contact spring lies flat on its relay contact and the lagging contact spring is acted on more strongly in its closed position. The contact forces should hereby be as far as possible the same magnitude and bounce should be reduced.

A contact arrangement to avoid voltage drops during the change of load resulting from products of combustion caused by arcing is known from DE 196 01 833 B4, which consists of only one single contact piece pair, the contact pieces of which are designed substantially crowned or spherical and are attached to the contact piece carriers. One of the contact piece carriers is designed so that during the closing process not only does its contact piece move onto the other one, but even after setting up it performs a small radial movement for self-adjustment. For this purpose the fixed contact piece has a large cylindrical recess for moving the contact piece outward, the edge of which, in the closing position of the two contact pieces, forms an enlarged contact surface for the contact in the form of an annular shoulder for the movable crowned contact. A friction process is associated with the adjustment movement, which removes the burn-off or outage deposited on the surface of the contact pieces and should transfer it to the recess in order to minimise contamination of the contact surfaces.

In order to reduce welding of contact pieces, during the production of a calotte in a partner of a single contact piece pair for a cam switch, the precisely-fitted installation of the second contact piece of the contact pair is made possible in accordance with DE 1 804 373 U through utilisation of a bearing gap. In this position one or both contact piece partners can then be attached using rivets, welding or the like.

DE 1 062 843 B presents a crater or hump formation on the contact surfaces of a single contact pair, at the back of which one or more notches, which do not extend to the contact surfaces, are inserted into the contact material in order to cool it.

A sintered or extruded contact piece of a single contact pair for switching devices with a hole is described in DE 35 28 890 A1, which serves as a repository for organometallic compounds or heavy metals.

According to DE 1803 662 C the contact surfaces for, in particular, push-switches are designed such that the contact makes contact at three points and thereby the central axis of one oscillating contact pin is automatically centred in relation to the central axis of the other contact pin.

DE 37 14 83 A describes by way of an introduction the difficulties involved in a precisely-fitted setting of flat contacts of a contact pair to one another. The main difficulty therein was seen as being that a burn-in was necessary for the final finish, while the contact pair was to be activated under supervision for such a long time, until the contact surfaces had been forged onto each other or had been adjusted by way of atomisation as a result of sparking.

### Technical Problem to be Solved

In the known contact arrangements for electrical switching devices having at least two parallel contact piece pairs the contact pieces tend to wear out non-uniformly. The arc resulting during the switching process will always preferably burn one of the contact piece pairs, because due to geometric tolerances one contact piece pair always opens later than the other one and thus draws the arc. Often mechanically possible asymmetries in the conduction of current also lead to electromagnetic fields such that they push the arc onto a preferred contact piece pair. Various disadvantages arise due to the non-uniform wearing out of the contact pairs in comparison with each other. Therefore the necessary proportion of contact piece material, usually silver or gold alloys, must be selected at a higher amount in order to ensure a safe switching behaviour throughout the service life of the switching devices. Since the arc continues to hit the same contact piece pair and burns this free of deposits, increased deposits resulting from the burn-off of the worn-out contact piece pair accumulate on the other contact piece pair. The contact resistance of the contact piece pair that is not worn out increases and can lead to the malfunction of this contact point. Therefore the total resistance of the switching devices can increase to more than double the desired resistance value. On the other hand, arrangements that ensure as far as possible a regular wearing out of the contact piece pairs require a very high constructive and above all production-related effort, which is associated with high costs.

### SUMMARY OF THE INVENTION

Hence there is a desire for a height-compensating self-adjusting contact piece geometry for contact arrangements having at least two contact piece pairs arranged in parallel in switching devices.

Accordingly, in one aspect thereof, the present invention provides a contact arrangement for high-power electrical switching devices having at least two circular contact piece pairs in a convex/flat or convex/convex contact piece pair of contact pieces, mechanically and electrically connected in parallel, wherein a contact surface of at least one contact piece of a contact piece pair has at least one central recess or at least one central projection.

Preferably, the contact surface has a single central recess the largest diameter of which is approximately ⅕ of the total diameter of the contact surface of the contact piece.

Preferably, the central recess is a funnel-shaped blind hole.

Alternatively, the central recess is a cylindrical through hole.

Alternatively, the contact surface is flat with several small central recess arranged around the centre of the contact surface.

Preferably, the contact piece pairs include flat contact pieces arranged on a fixed contact carrier of the switching device and having the at least one central recesses.

Preferably, the convex contact pieces of the contact piece pairs are arranged on a movable contact piece carrier of the switching device and have no recesses.

According to a second aspect, the present invention provides a contact arrangement for high-power electrical switching devices having at least two circular contact piece pairs in a convex/concave or flat/concave contact piece pair of contact pieces, mechanically and electrically connected in parallel, wherein a contact surface of at least one contact piece of a contact piece pair has at least one central projection.

Preferably, the contact surface has a single central projection the largest diameter of which is approximately ⅕ of the total diameter of the contact surface of the contact piece.

Preferably, the contact surface has several small central projections arranged around the centre of the contact surface.

Preferably, the concave contact pieces of the contact piece pairs are arranged on a fixed contact carrier of the switching device and only these contact piece partners have the at least one central projection.

According to a third aspect, the present invention provides a contact arrangement for high-power electrical switching devices having at least two circular contact piece pairs electrically connected in parallel, wherein a first contact piece pair has a contact piece with at least one central recess and a second contact piece pair has a contact piece with at least one central projection.

### Advantages of the Invention

With the invention, the proportion of the contact material used for the contact pieces, in particular alloys of precious metals, can be reduced, since not every parallel contact piece pair needs to be designed just as large as a single switching contact piece pair. Furthermore, the accuracy requirements for the production and assembly of switching devices can be reduced. Ultimately, a lower and more stable contact resistance arises during the operation of a switching device.

### BRIEF DESCRIPTION OF THE DRAWINGS

A preferred embodiment of the invention will now be described, by way of example only, with reference to figures of the accompanying drawings. In the figures, identical structures, elements or parts that appear in more than one figure are generally labeled with a same reference numeral in all the figures in which they appear. Dimensions of components and features shown in the figures are generally chosen for convenience and clarity of presentation and are not necessarily shown to scale. The figures are listed below.

FIG. 1 shows a sectional illustration of two parallel contact piece pairs according to the prior art;

FIG. 2a is a partial sectional illustration of a first contact piece according to the preferred embodiment of the present invention, in new condition;

FIG. 2b is a partial sectional illustration of the contact piece of FIG. 2a after frequent switching under load;

FIG. 3 is a sectional view of two parallel contact piece pairs according to the preferred embodiment, after frequent switching under load;

FIG. 4 is an isometric view of a contact piece according to a second embodiment of the invention in new condition; and

FIGS. 5, 6 & 7, illustrate further embodiments of a contact piece according to the present invention.

### DETAILED DESCRIPTION OF THE PREFERRED EMBODIMENTS

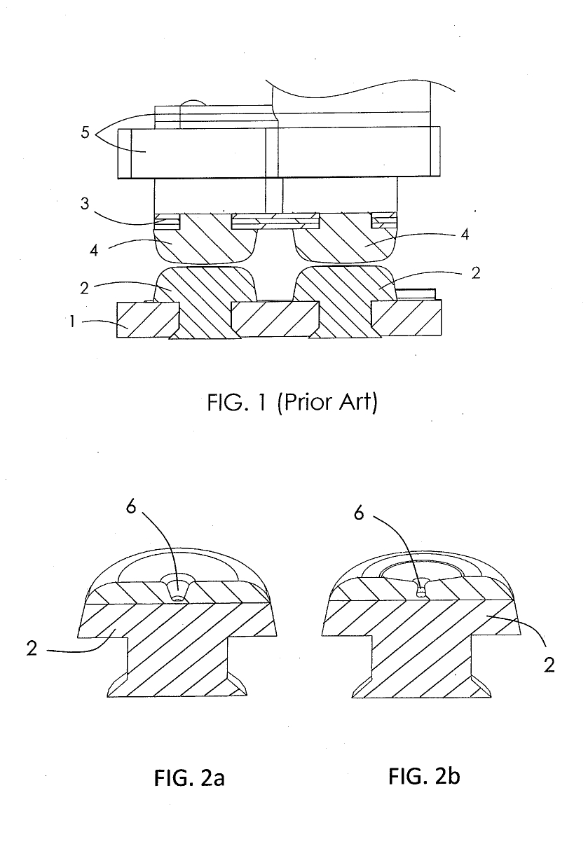

FIG. 1 shows a sectional illustration of two parallel switching contact piece pairs according to the prior art. Two identical circular contact pieces 2 having one substantially flat contact surface are riveted to a lower fixed contact piece carrier 1. Both contact pieces 2 are connected to each other electrically and mechanically parallel over the fixed contact piece carrier 1. A movable contact arrangement is situated above the fixed contact arrangement. It consists of a movable contact piece carrier 3 able to be deflected against spring tension, for example a multi-layer spring clamped on one side, to which two identical circular contact pieces 4 having lightly crowned contact piece surfaces are riveted on the exposed deflectable end such that they face in pairs the fixed contact pieces 2. The two movable contact pieces 4 are also therefore mechanically and electrically connected to each other. In the figure the two parallel contact piece pairs 2, 4 make contact in each case. A switching mechanism of an unspecified switching device produces the necessary contact pressure via a deflecting mechanism 5, which provides the closing and opening state of the contact pieces 2, 4. A current to be switched, from 100 A for example, is divided by the two contact piece pairs 2, 4. At a correspondingly high contact pressure the contact pairs 2, 4 deform in cooperation with the low level of the switching arcs, so that after a certain period very small manufacturing tolerances within the range of <0.1 mm, already self-adjusting, compensate themselves and identical switching times as well as a uniform current distribution of the switching current on the contact piece pairs 2, 4 are achieved. Greater height tolerances between the switching piece pairs are not, however, compensated.

In FIG. 2a a first step according to the invention is shown which clearly helps to reinforce the abovementioned effect. The fixed contact 2 according to FIG. 1 is for this purpose provided on its contact surface with a central recess 6. The recess 6 is described as funnel-shaped in the illustration, but it can also, however, have the form of a blind hole or through-hole (as shown in FIG. 7). The largest diameter of the funnel-shaped recess 6 amounts to only a small percentage of the contact surface and thus approximately ⅕ of the contact diameter of the contact rivet 2, so that sufficient contact surface and burn-off material remains. In the example, the recess 6 does not penetrate the contact material.

FIG. 2b shows an illustration of the fixed contact piece according to FIG. 2a after a large number of switching cycles under load. The relatively soft contact material, for example a plated silver alloy on the contact rivet 2, is extruded in the direction of the funnel-shaped recess 6 during the switching operation, whereby there is overall a small lowering of the contact surface. In the flat contact surface of the fixed contact piece 2 the crowned surface of the movable contact piece 4 forges a small depression, and the funnel-shaped recess 6 constricts the extruded material. This deformation process slows down as soon as the heights of the contact piece 2, 4 of the parallel contact piece pairs have aligned to each other.

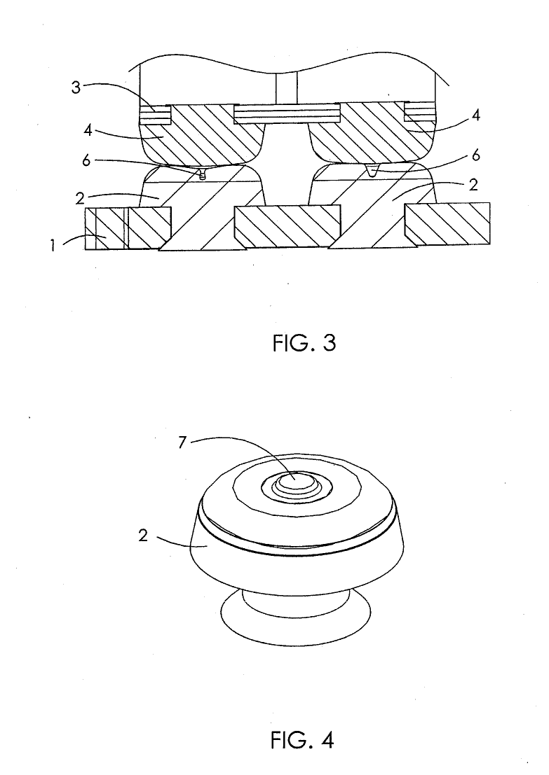

FIG. 3 shows the state after a tolerance compensation. The two contact piece pairs 2, 4 switch at exactly the same time, thus draw approximately the same size of arcs and wear out over the service life of the switching device correspondingly and synchronously. Before such a condition is set, the contact piece pair 2, 4, which is later contacted, which is the contact piece pair on the right in FIG. 3, receives the usual sooting due to a powerful arc formation according to the prior art. With the height-related compensation due to the thermo-mechanical contact material extrusion on the contact piece pair 2, 4 first contacting, that is the left one in FIG. 3, soot and other deposits are burnt off initially on the second contacting contact piece pair and both contact piece pairs 2, 4 exhibit shiny contact surfaces. Therefore the contact pieces 2, 4 of the parallel switching contact piece pairs can be sized smaller than those not using the invention. If the contact pieces 2, 4 are not homogeneous, but carry a rolled-on contact layer made of a precious metal on an electrically conductive support layer, this contact layer is in any case not penetrated during the switching operation in the course of the height alignment of the contact piece pairs 2, 4 to each other.

If both contact pieces 2, 4 of a contact piece pair have a lightly crowned contact surface, then embodiments are also possible such that both contact pieces 2, 4 have a central recess 6.

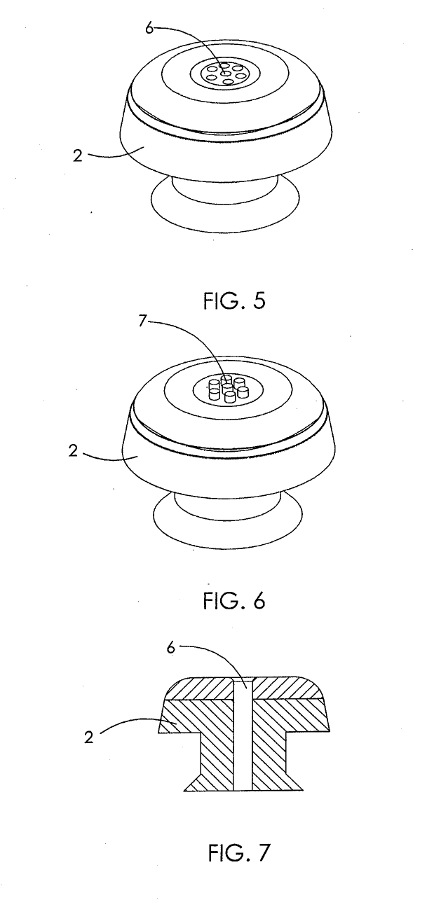

Instead of a central recess 6 several smaller recesses positioned around the centre of the contact surface can also be formed in the contact piece(s) 2, 4. Such a variant is illustrated figuratively in FIG. 5.

In FIG. 4 a second embodiment of a fixed contact piece 2 according to the invention is illustrated. A small local projection 7 is provided in the centre of the fixed contact piece 2, which as long as it is first contacted and deformed by a crowned counter contact piece 4 of one of the contact pairs 2, 4 under goes defective adjustment during the switching, until a self-adjusting height compensation of parallel contact piece pairs 2, 4 has taken place mutually. Thereafter the two parallel contact piece pairs 2, 4 switch synchronously. Advantageously the contact surface of the circular fixed contact piece 2 is geometrically formed so that the central projection 7 rises up from a flat depression, its diameter amounting to approximately ⅕ of the total diameter of the contact surface of the contact piece. So contact material flows into the depression during the engagement by the circular movable counter contact piece 4 and after the height compensation a sufficient contact surface is available as bum-off reserve.

Instead of a central projection 7, several small projections 7 can also be provided around the contact centres of the fixed contact piece 2. Also here both contact piece partners of a contact piece pair 2, 4 can carry one or several central projections 7. These variants are figuratively illustrated in FIG. 6.

If contact piece pairs are preferably designed such that one contact piece is flat and the other is lightly crowned or that both contact pieces are lightly crowned, defined contact points result and possible shifts of the contact pieces to each other may be tolerated well. An additional property is that through the combination resulting from the high surface pressure of a flat/crowned or crowned/crowned contact pair together with a thermal influence of the contact materials by the switching arc, a light deformation of the contact piece partner results. This deformation leads to a reduction in the amount of primary switching contact piece pairs, so that another parallel contact piece pair can also engage. The arrangement can compensate geometric tolerances of <0.1 mm and to some extent already has self-adjusting properties. These properties can be encouraged in the interest of a uniform wearing out of two or more parallel contact piece pairs, without the contact pieces wearing out too quickly due to increased wear of contact materials, wherein one or more central recesses are inserted into one or both contact pieces of each contact piece pair. Hereby, during the switching processes, the relatively soft material of the first contact piece of a contact piece pair that is in contact and is provided with the recess or the recesses is extruded in the direction of the recess(es) and in terms of height there is a lowering of the actual contact surface until the second contact piece pair closes or, in the case of additional parallel contact piece pairs, these close. All contact piece pairs are engaged, that is, the two or more contact piece pairs statistically draw the same number of arcs, this slows down the effect and the contact piece pairs work parallel synchronously.

According to additional embodiments of the invention, one or more central projections on the contact surfaces of a contact piece of a contact piece pair or a combination of parallel contact pairs having recesses and projections lead to the same effect.

The invention is suitable in particular for the production and operation of switching relays, contactors, circuit-breakers and other electromagnetically actuated switching devices of greater performance. With the invention, manufacturing-related height tolerances of parallel switching contact piece partners are able to be balanced up to ±0.5 mm.

In the description and claims of the present application, each of the verbs “comprise”, “include”, “contain” and “have”, and variations thereof, are used in an inclusive sense, to specify the presence of the stated item but not to exclude the presence of additional items.

Although the invention is described with reference to one or more preferred embodiments, it should be appreciated by those skilled in the art that various modifications are possible. Therefore, the scope of the invention is to be determined by reference to the claims that follow.

1. Contact arrangement for high-power electrical switching devices having at least two circular contact piece pairs in a convex/flat or convex/convex contact piece pair of contact pieces, mechanically and electrically connected in parallel,
wherein a contact surface of at least one contact piece of a contact piece pair has at least one central recess or at least one central projection.

2. The contact arrangement of claim 1, wherein the contact surface has a single central recess the largest diameter of which is approximately ⅕ of the total diameter of the contact surface of the contact piece.

3. The contact arrangement of claim 2, wherein the central recess is a funnel-shaped blind hole.

4. The contact arrangement of claim 1, wherein the central recess is a cylindrical through hole.

5. The contact arrangement of claim 1, wherein the contact surface is flat with several small central recess arranged around the centre of the contact surface.

6. The contact arrangement of claim 1, wherein the contact piece pairs include flat contact pieces arranged on a fixed contact carrier of the switching device and having the at least one central recesses.

7. The contact arrangement of claim 6, wherein the convex contact pieces of the contact piece pairs are arranged on a movable contact piece carrier of the switching device and have no recesses.

8. Contact arrangement for high-power electrical switching devices having at least two circular contact piece pairs in a convex/concave or flat/concave contact piece pair of contact pieces, mechanically and electrically connected in parallel,
wherein a contact surface of at least one contact piece of a contact piece pair has at least one central projection.

9. The contact arrangement of claim 8, wherein the contact surface has a single central projection the largest diameter of which is approximately ⅕ of the total diameter of the contact surface of the contact piece.

10. The contact arrangement of claim 8, wherein the contact surface has several small central projections arranged around the centre of the contact surface.

11. The contact arrangement of claim 8, wherein the concave contact pieces of the contact piece pairs are arranged on a fixed contact carrier of the switching device and only these contact piece partners have the at least one central projection.

12. Contact arrangement for high-power electrical switching devices having at least two circular contact piece pairs electrically connected in parallel, wherein a first contact piece pair has the contact piece of claim 1 and a second contact piece pair has the contact piece of claim 8.
